(19) United States
(12) Patent Application Publication
(10) Pub. No.: US 2025/0323547 A1
(43) Pub. Date: Oct. 16, 2025

(54) TOOTH TIP CAPS FOR ELECTRIC MACHINE STATORS

(71) Applicant: BorgWarner Inc., Auburn Hills, MI (US)

(72) Inventors: Kirk E. Neet, Noblesville, IN (US); Johnnie Evans, Anderson, IN (US)

(21) Appl. No.: 19/170,830

(22) Filed: Apr. 4, 2025

Related U.S. Application Data
(60) Provisional application No. 63/632,807, filed on Apr. 11, 2024.

(51) Int. Cl. H02K 3/487

(52) U.S. Cl. CPC H02K 3/487

(57) ABSTRACT

A tooth tip cap for an electric machine includes a first connection portion and a second connection portion spaced apart from the first connection portion. A first leg and a second leg connect the first connection portion to the second connection portion. The tooth tip cap is configured such that each leg partially reduces an air gap of a radial insertion slot winding of a stator.

### CROSS REFERENCE TO RELATED APPLICATIONS

This application claims the benefit of an earlier filing date from U.S. Provisional Application Ser. No. 63/632,807 filed Apr. 11, 2024, the entire disclosure of which is incorporated herein by reference.

### BACKGROUND OF THE INVENTION

Exemplary embodiments pertain to the art of electric machines, and more particularly to electric machines including a radially inserted continuous wire winding.

Electric machines are machines that operate using electromagnetic forces, such as electric motors, electric generators, and similar machines. A typical electric machine includes a stator and a rotor. Included within the stator are multiple windings retained in slots in the stator.

In a hairpin stator, U-shaped hairpin windings are axially inserted into the slots and the opposite ends of the windings are twisted and welded together to form a composite winding. This design is beneficial in constructions where axial insertion allows for laminations stamped with a semi-closed slot opening at the inside dimension (ID) of the slot and lamination teeth. Semi closed slot openings are beneficial for efficiency, performance and noise. Windings in a hairpin stator require a substantial number of twists and welds to properly assemble a stator. As a result, assembly of the stator is time consuming and complex.

Alternatively stators may be constructed with a radially inserted continuous wire. In this example, the stator includes slots at an inner diameter with radially inward facing slot opening. The slot openings are large enough to allow the wire to pass from the ID into the slots. Radial insertion designs reduce the required number of twists and welds during assembly. However, due to the radial insertion, existing radial designs result in a large slot opening along the inner diameter which can decrease efficiency and performance and can increase noise.

### BRIEF DESCRIPTION OF THE INVENTION

Embodiments of the disclosure provide a tooth tip cap for an electric machine includes a first connection portion and a second connection portion spaced apart from the first connection portion. A first leg and a second leg connect the first connection portion to the second connection portion. The tooth tip cap is configured such that each leg partially reduces an air gap of a radial insertion slot winding of a stator.

Embodiments of the disclosure further provide a stator includes multiple stator teeth arranged about an inner diameter of the stator and extending radially inward. Multiple winding slots are included in the stator and each winding slot in the multiple winding slots is defined between two corresponding stator teeth of multiple stator teeth. Multiple tooth tip caps are included, with each tooth tip cap including a first leg and a second leg. Each leg is disposed in a corresponding winding slot of the plurality of winding slots.

### BRIEF DESCRIPTION OF THE DRAWINGS

The following descriptions should not be considered limiting in any way. With reference to the accompanying drawings, like elements are numbered alike:

FIG. 1 depicts tooth tip caps for installation in a radial insertion stator;

FIG. 2 depicts a partial view of a stator including tooth tip caps according to one example;

FIG. 3 depicts a partial view of a stator including tooth tip caps according to another example;

FIG. 4 depicts a partial view of a stator including tooth tip caps according to another example;

FIG. 5 depicts a tooth tip cap of the stator of FIG. 4, isolated from the context of the stator;

FIG. 6 depicts a partial cross section of a stator from an axial facing view;

FIG. 7 illustrates a partial view of a tooth tip cap configuration including a connecting bridge; and

FIG. 8 illustrates a partial view of a stator including tooth tip caps according to another example.

### DETAILED DESCRIPTION OF THE INVENTION

A detailed description of one or more embodiments of the disclosed apparatus and method are presented herein by way of exemplification and not limitation with reference to the Figures.

In order to decrease the operational penalties associated with the relatively large radially inward facing slot opening of a stator designed for radial winding insertion, a tooth tip cap is inserted into each stator slot after the corresponding radial winding is inserted. The tooth tip cap partially closes the radially inward facing slot opening, thereby reducing the drawbacks associated with using the radial insertion stators.

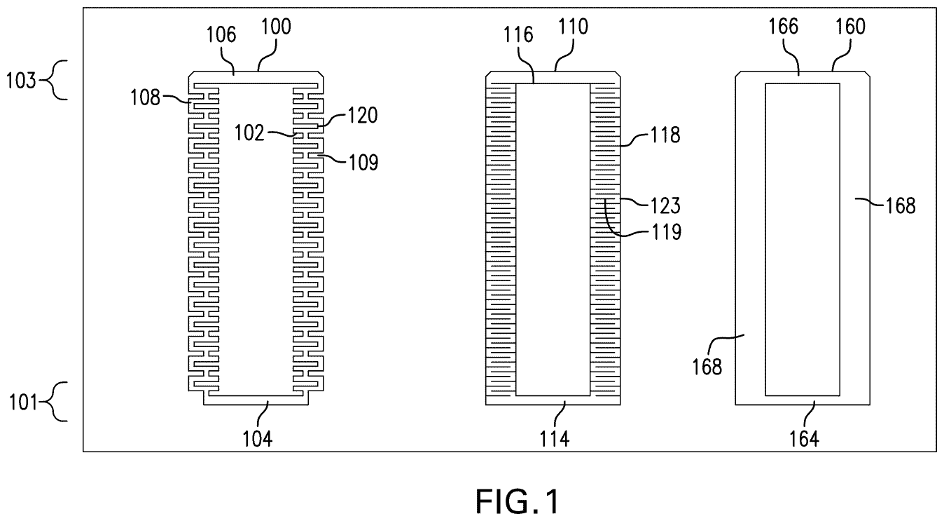

FIG. 1 illustrates exemplary tooth tip caps 100, 110, 160 that can be utilized within a radial insertion stator according to any of the designs described herein. In some stators tooth tip caps 100, 110, 160, or any combination thereof, can be used in a circumferentially alternating fashion and/or in combination with alternative tooth tip cap configurations.

Each tooth tip cap 100, 110, 160 is constructed of a stamped or cut magnetic permeable material (e.g. steel) to reduce eddy current losses. The tooth tip caps 100, 110, 160 are in the range of about 0.2 mm to about 0.5 mm thick in a radial direction relative to an axis of the stator in which the tooth tip caps 100, 110, 160 will be installed. The tooth tip cap 100 may be stamped from an electrical lamination material. To further reduce eddy current losses, the tooth tip cap 100 may be formed from high silicon electrical steel such as 3.5% silicon or 6.5% silicon.

Each of the tooth tip caps 100, 110, 160 includes a connection portion 104, 114, 164 at a first axial end 101 and a second connection portion 106, 116, 166 at a second axial end 103 opposite the first axial end 101. The axial connection portions 104, 106, 114, 116, 164, 166 are connected via legs 108, 118, 168. In one example, the entire tooth tip cap 100, 110, 160 is stamped, cut, or both from a single sheet of material.

In both the first example tooth tip cap 100 and the second example tooth tip cap 110, the legs 108, 118 are tortuous, including turns 120, 123 and slots 109, 119. The inclusion of the slots 109, 119 in the legs 108, 118 further reduces the eddy currents.

In examples (e.g. tooth tip cap 160) where eddy currents associated with the tooth tip cap 160 provide acceptable performance, the legs 168 may be straight, or include minimal turns.

In the first example tooth tip cap 100, the legs 108 include relatively large slots 109 between turns 120. The slots 109 reduce eddy current losses that can be incurred due to the inclusion of the tooth tip cap 100 at the expense of increasing air gaps. The large size of the slots 109 allow for the tooth tip cap 100 to be manufactured using a punching technique but requires a larger air gap.

In the second tooth tip cap 110, the legs 118 include substantially smaller slots 119 between the turns 123. As with the first example, the slots 119 reduce eddy current losses incurred by the presence of the tooth tip cap. The smaller slots 119 increase the amount of tooth tip material present, thereby further closing the radially facing winding slots. However, the smaller slots 119 require a manufacturing process that includes cutting and milling.

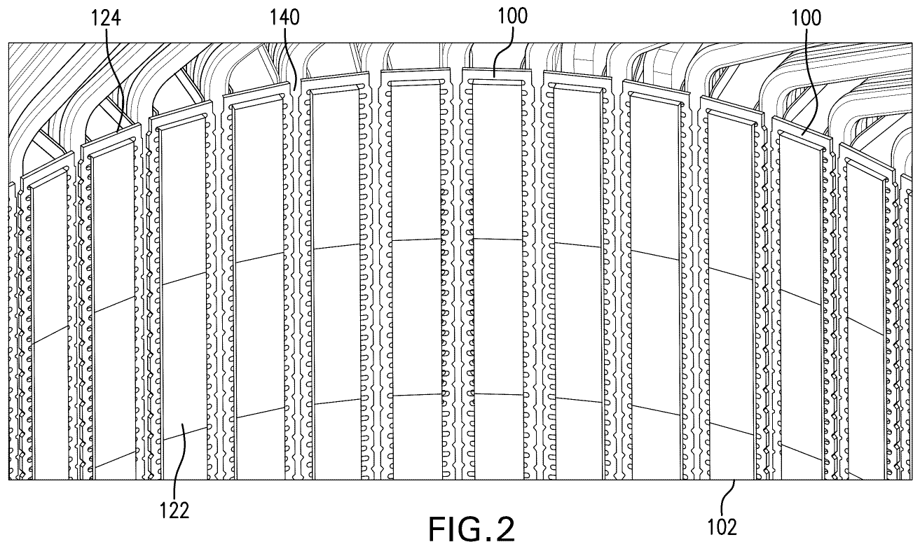

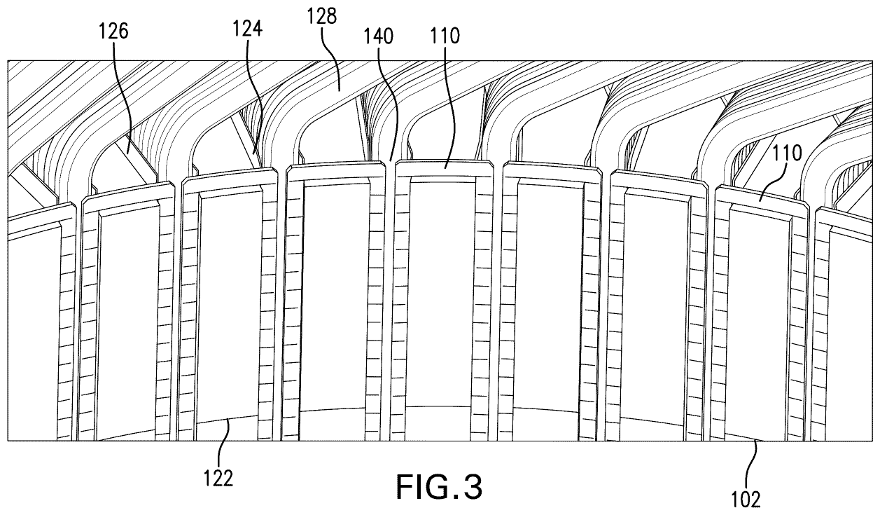

With continued reference to FIG. 1, FIG. 2 illustrates the first tooth tip cap 100 configuration inserted into a stator 102 and FIG. 3 illustrates the second tooth tip cap 110 inserted into the stator 102. In one example the stator 102 is a laminated stator constructed of axially stacked laminations. The stator 102 includes multiple teeth 122 extending radially inwards, with radial insertion slots 124 being defined between adjacent teeth 122. During assembly an insulative liner 126 is installed into each slot 124. After the liner 126, windings 128 are inserted radially into the slot 124, and the tooth tip caps 100, 110 are installed. Each tooth tip cap 100, 110 is positioned around a radially inward end of one of the teeth 122 such that the axial connection portions 104, 106, 114, 116 of the tooth tip cap 100, 110 extend beyond axial ends of the teeth 122, and each of the tortuous connectors 108, 118 is positioned within one of the slots 124 adjacent to the tooth 122 about which the tooth tip cap 100, 110 is disposed.

The resulting configuration includes the legs 108, 118 of each tooth tip cap 100, 110 being positioned in two adjacent radially aligned slots 124, and each slot 124 receiving legs 108, 118 of two tooth tip caps 100, 110. An air gap 140 is defined between the legs 108, 118 received in each slot 124.

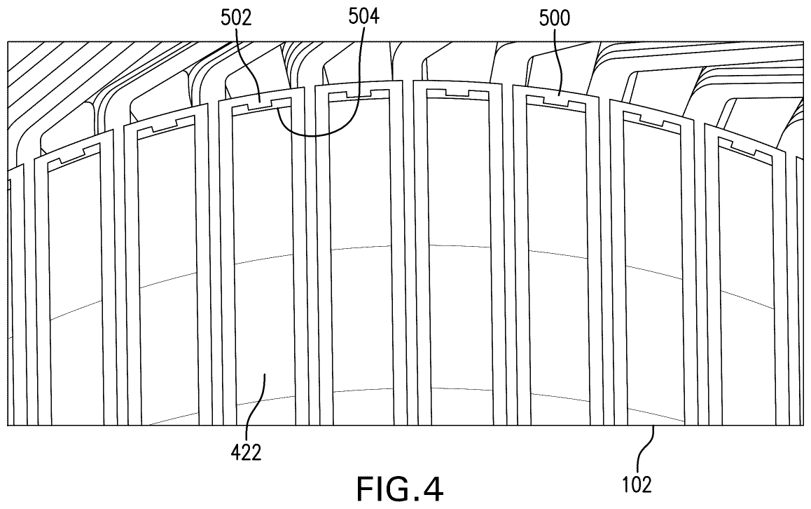

With continued reference to FIGS. 1-3, FIG. 4 illustrates another example tooth tip cap 500 installed in the stator 102 and maintained in position via an axially extending retention tab 502. The tooth tip cap 500 can be any tooth tip cap configuration (tooth tip cap 100 110, or 160) illustrated in FIG. 1, with the axially extending retention tab 502 extending from either or both of the axial connectors of the tooth tip cap 500. Each tooth 422 of the stator 102 includes an axially extending lip 504. The axially extending lip 504 extends axially outward from the tooth 422. When installing the tooth tip caps 500. The retention tabs 502 flex to pass over the axially extending lip 504, then snap back into place once the tooth tip cap 500 is fully in place. The interaction between the axially extending retention tab 502 and the lip 504 prevents the tooth tip cap 500 from vibrating loose from the slot, falling out of the slot due to gravity, or otherwise failing out of position.

In alternative implementations, the retention tabs 502 may be friction fit to the tooth 422 or may fit into a corresponding hole or divot in the tooth 422 further assisting the retention tab 502 in maintaining the tooth tip cap 500 in position. In one example, the hole or divot in the tooth 422 may be created via inclusion of a hole at a corresponding location in the teeth of the one, two, or three axially endmost laminations at each axial end of the stator 100.

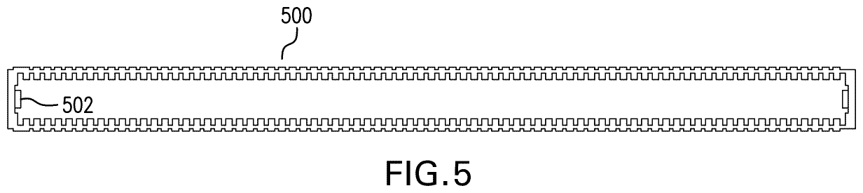

With continued reference to FIGS. 1-5, FIG. 6 illustrates a close up view of two slots 602 including slot liners 606. In order to prevent the tip tooth caps 608 from inadvertently forming electric current paths with the windings 610, a liner wedge 612 is positioned within each slot 602 and between the tip tooth cap(s) 608 and the winding 610 of that slot 602. The liner wedge 612 is constructed of the same material as the liner 606, and can be inserted in the same assembly step as the liner 606. In addition, each of the teeth 614 includes circumferentially extending nubs 616 at or near an inner diameter of the stator. The circumferential distance between the two nubs 616 of one slot, is larger than the width of the winding 610 allowing the winding to be installed. The nubs 616 have a radial height of about 0.3 mm along a radius of the stator.

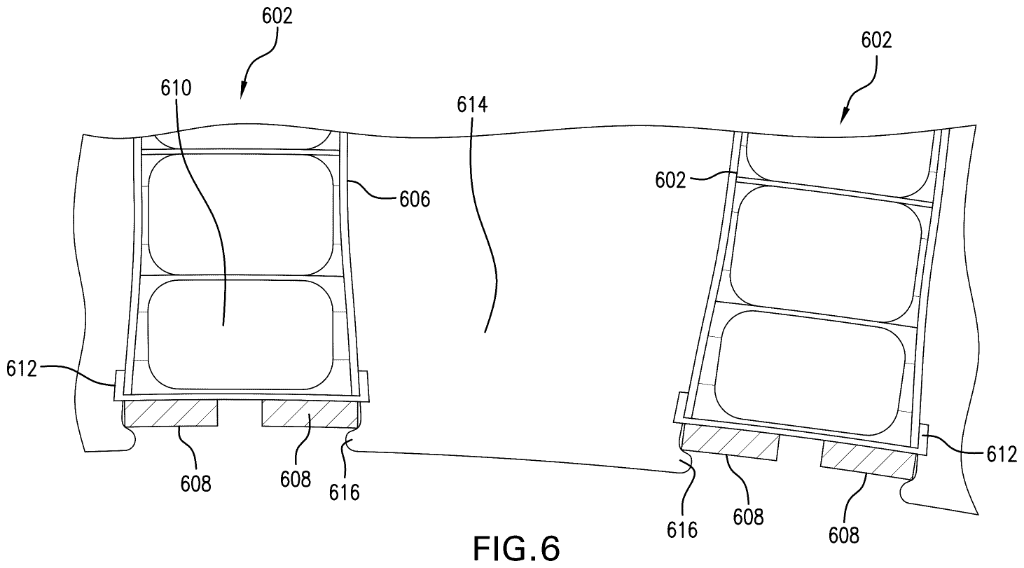

In the example of FIG. 6, the tooth tip caps 608 snap radially outward of the nubs 616, and the nubs 616 maintain the tooth tip caps 608 in position.

Referring now to all of FIGS. 1-6, in some variations eddy currents may be further reduced by stacking multiple tooth tip caps 100, 110, 160, 500 upon each other in the radial direction. In one example, one tooth tip cap 100, 110, 160, 500 may be stamped from 0.25 mm thick lamination material and installed into the stator slot 124. Another tooth tip cap 100, 110, 160, 500 maybe snapped behind the nubs of one lamination tooth, effectively combining the examples of FIG. 6 with the example of FIGS. 1-5. The second tooth tip cap 100, 110, 160, 500 is also about 0.25 mm thick, resulting in a composite cap thickness in the radial direction of about 0.5 mm. The composite thickness represents a physical thickness of the tooth tip caps and is not inclusive of any radial spacing between the tooth tip caps on a single tooth.

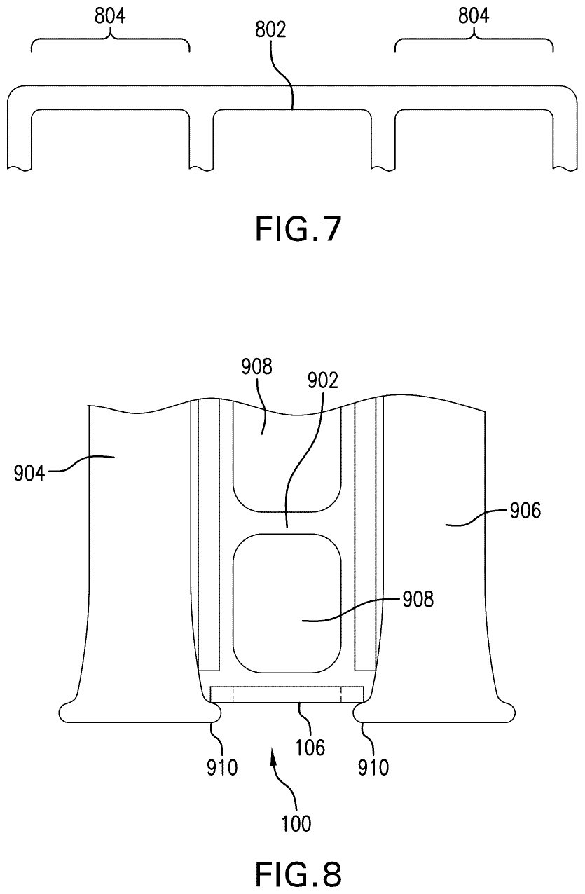

In yet another variation, illustrated in FIG. 7, the tooth tip caps 100, 110, 160, 500 may be stamped or cut with at least one bridge connecting two or more adjacent tooth tip caps 804. The bridge(s) 802 in this example provide a structural connection between two or more adjacent tooth tip caps 100, 110, 160, 500 and are as axially thin as possible while still maintaining structural integrity, thereby minimizing the impact of the bridge 804 on the electrical properties of the tooth tip caps 100, 110, 160, 500.

In yet another variation, illustrated in FIG. 9, each tooth tip cap 100 may be snapped into a winding slot 902, defined between two radially adjacent stator teeth 904, 906. The tooth tip cap 100 is inserted into the slot 900 after insertion of the windings 908 such that the tooth tip cap 100 is radially inward of the windings 908 in the assembled stator. The tooth tip cap 100 is retained in position within the slot 902 by circumferentially extending lips 910 at the base of each tooth 904. In the example of FIG. 9, the axial connection portion 106 of the tooth tip cap 100 does not extend beyond an axial end of the stator teeth 904, 906.

The variation illustrated in FIG. 9 may utilize any example tooth tip cap configuration, and a stator assembly constructed using the variation of FIG. 9 may include any combination of the example tooth tip cap configurations distributed between the winding slots 902.

The term “about” is intended to include the degree of error associated with measurement of the particular quantity based upon the equipment available at the time of filing the application. For example, “about” includes a range of ±8% of a given value.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims.

What is claimed is:

1. A tooth tip cap for an electric machine, the tooth tip cap comprising:
a first connection portion and a second connection portion spaced apart from the first connection portion;
a first leg and a second leg connecting the first connection portion to the second connection portion; and
wherein the tooth tip cap is configured such that each leg partially reduces an air gap of a radial insertion slot winding of a stator.

2. The tooth tip cap of claim 1, wherein each of the first leg and the second leg includes a set of slots.

3. The tooth tip cap of claim 1, further comprising a first retention tab extending axially from one of the first connection portion and the second connection portion, relative to an axis of a stator of the electric machine.

4. The tooth tip cap of claim 3, further comprising a second retention tab extending axially from the other of the first connection portion and the second connection portion.

5. The tooth tip cap of claim 3, wherein the first retention tab extends toward the other of the first connection portion and the second connection portion.

6. The tooth tip cap of claim 1, wherein the tooth tip cap is a single magnetic permeable material.

7. A stator comprising:
a plurality of stator teeth arranged about an inner diameter of the stator and extending radially inward;
a plurality of winding slots, wherein each winding slot in the plurality of winding slots is defined between two corresponding stator teeth of the plurality of stator teeth; and
a plurality of tooth tip caps, each tooth tip cap including a first leg and a second leg, each leg being disposed in a corresponding winding slot of the plurality of winding slots.

8. The stator of claim 7, wherein a first leg of each tooth tip cap is disposed in a different corresponding winding slot than the second leg of the tooth tip cap.

9. The stator of claim 7, wherein each tooth tip cap includes a first connection portion and a second connection portions spaced apart by the first and second legs.

10. The stator of claim 9, wherein each of the first legs and the second legs includes a set of slots.

11. The stator of claim 9, further comprising a first retention tab extending axially from one of the first connection portion and the second connection portion, relative to an axis of the stator.

12. The stator of claim 11, further comprising a second retention tab extending axially from the other of the first connection portion and the second connection portion.

13. The stator of claim 11, wherein the first retention tab extends toward the other of the first connection portion and the second connection portion.

14. The stator of claim 11, wherein the first retention tab is received in an intrusion in the stator tooth about which the tooth tip cap is disposed.

15. The stator of claim 14, wherein the stator is a laminate stator, and wherein the intrusion in the stator comprises a slot in at least two axially end most lamination layers of the laminate stator.

16. The stator of claim 7, wherein each stator tooth includes a first nub extending circumferentially into a first adjacent slot at an inner diameter of the stator tooth and a second nub extending circumferentially into a second adjacent slot at the inner diameter of the stator tooth.

17. The stator of claim 16, wherein the tooth tip cap is disposed radially outward of the first nub and the second nub.

18. The stator of claim 7, wherein each winding slot includes an insulative slot liner, a rotor winding, and a liner wedge disposed radially between the rotor winding and each of the tooth tip caps disposed about the stator teeth defining the slot.

19. The stator of claim 7, further comprising a second tooth tip cap disposed around stator tooth.

20. The stator of claim 7, wherein each tooth tip cap further includes a connecting bridge structurally connecting the tooth tip cap to at least one circumferentially adjacent tooth tip cap.

21. The stator of claim 7 wherein the tooth tip cap is formed of magnetic permeable material.

22. The stator of claim 21 wherein the tooth tip cap is formed from electrical steel lamination material.

23. The stator of claim 22 wherein the tooth tip cap is formed from high silicon electrical lamination material.

24. The stator of claim 23 wherein the tooth tip cap is formed of at least 4% silicon electrical lamination material.
